(19) United States
(12) Patent Application Publication
(10) Pub. No.: US 2026/0139158 A1
(43) Pub. Date: May 21, 2026

(54) FILM TAPES

(71) Applicant: VYBOND GROUP, INC., Franklin, KY (US)

(72) Inventors: Tim CROWDER, Portland, TN (US); Nick ADDINGTON, Bowling Green, KY (US); Paul CONNOLLY, Evansville, IN (US); Ryan MCCOY, Evansville, IN (US)

(21) Appl. No.: 19/349,298

(22) Filed: Oct. 3, 2025

Related U.S. Application Data
(60) Provisional application No. 63/704,797, filed on Oct. 8, 2024.

(51) Int. Cl. C09J 7/24

(52) U.S. Cl. CPC C09J 7/243; C09J 2203/346; C09J 2301/16; C09J 2301/312; C09J 2423/006

(57) ABSTRACT

A tape can include a polyethylene layer and an adhesive layer. In illustrative embodiments, the tape can include one or more of dual-edge slitting or microfractures in one or more edges thereof to promote tearability.

### CROSS REFERENCE TO RELATED APPLICATION

The present disclosure claims priority to and the benefit of U.S. Provisional Application 63/704,797, entitled “Polyethylene Film Tapes,” filed on Oct. 8, 2024, the content of which is incorporated by reference herein in its entirety.

### BACKGROUND

The present disclosure relates to tapes, and particularly to film tapes. More particularly, the present disclosure relates to film tapes comprising polyethylene.

### SUMMARY

According to the present disclosure, a tape of the present embodiments includes a polyethylene layer and an adhesive layer. In illustrative embodiments, the tape can include one or more of dual-edge slitting or microfractures in one or more edges thereof to promote tearability.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1A is a perspective view of one embodiment of tape of the present disclosure in which a pair of rolls has opposed serrations formed along an edge thereof;

FIG. 1B is a schematic front view of tape of FIG. 1A having an adhesive layer, a backing layer, and a release liner;

FIG. 1C is a schematic top view of the tape of the present embodiments having the backing layer, the adhesive layer, and the release liner of FIG. 1B in a roll;

FIG. 2A is a perspective view of another embodiment of a tape of the present disclosure having microfractures formed in an edge thereof;

FIG. 2B is a magnified perspective view of the edge of FIG. 2A; and

FIG. 3 is an example embodiment of a score knife bank set up machine used to modify the tape of FIGS. 1A-2B.

### DETAILED DESCRIPTION

A polyethylene tape in accordance with the present disclosure provides for clean masking lines and easier hand tearing as compared to comparative tapes. The tape can include a polyethylene layer and an adhesive layer. To facilitate tearing, the tape of the present embodiments can include a perforated or weakened edge. The perforated edge can be formed on one or more edges of the tape to improve ease of tearability. A person skilled in the art will recognize that polyethylene is not an easily tearable material, and therefore at least one novel aspect of the present disclosure includes a polyethylene tape that has a tearability that resembles that of comparative tapes lacking the perforated or weakened edge. It will be appreciated that the “tearability” of a tape is understood by one skilled in the art to refer to the ease and/or difficulty with which tape tears, and is measured by industry standards known to those skilled in the art.

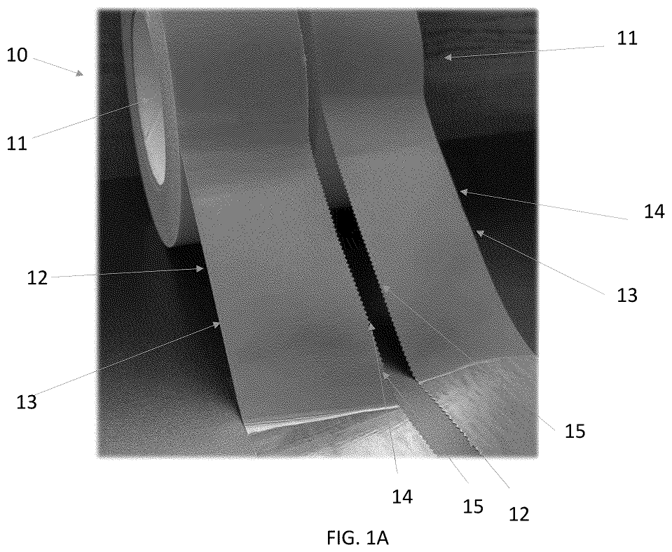

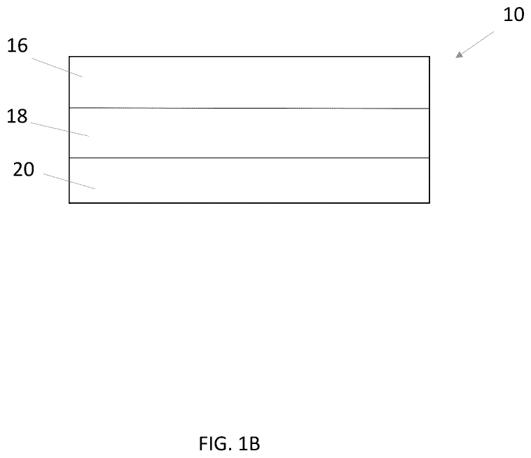

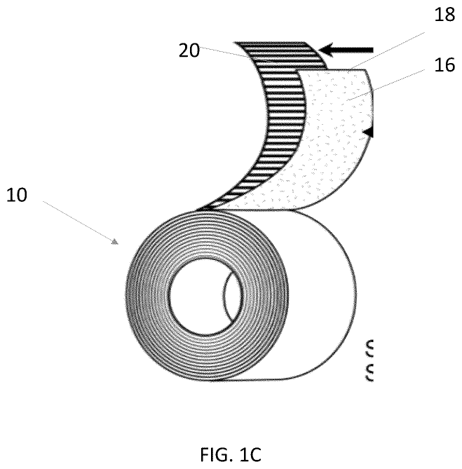

FIG. 1A illustrates an exemplary embodiment of a tape 10 of the present disclosure. As shown, the tape 10 can include dual-edge slitting to facilitate ease of tearability. For example, dual-edge slitting of the tape 10 can include a first edge 12 having a straight, or substantially straight, edge 13, while a second edge 14 includes a serrated, perforated, or pinked edge 15, with the terms “serrated,” “perforated,” and “pinked” being used interchangeably for the purposes of the present disclosure. The first edge 12 being straight 13 can provide for clean masking while the second edge 14 being serrated 15 can provide for ease of hand tearability.

The serrations 13 can concave or U-shaped grooves that reduce a width of the tape 10. As shown, the serrations 13 can be spaced substantially uniformly along the second edge 14 to form a repeating pattern of the grooves made therein.

Manufacture of the tape 10 can include each roll 11 being manufactured one at a time or two at a time as shown in FIG. 1A. In such embodiments, the serrations 15 can instead be formed on the first edge 12, while the second edge 14 includes the straight, or substantially straight, edge 13. This customization can allow for end use and variability in application of the tapes, which can account for the types of applications in which the tape is used, the handedness of the user, and so forth.

For example, when two rolls 11 are manufactured, they can be produced as mirror images of one another, with serrations along the second edges 14 being opposite one another and the straight edge of the first edge 12 being opposite from each other. Such manufacturing techniques can allow for segregation of rolls 11 into those having left or right side serrations, which can allow for consistency among shipments of boxes of such rolls 11 to consumers. The ability to vary the location of the serrations on the

The adhesive tape 10 may be comprised of multiple layers. For example, as shown in FIG. 1B, the tape 10 may include a first layer or backing layer 16 comprising polyethylene material, and the second layer 18 comprising an adhesive that is directly adjacent to the first layer 16. In some embodiments, first layer 16 can include a polyethylene, a polypropylene, or a combination thereof. Illustrative polyethylenes can include homopolymers of ethylene or copolymers of ethylene. In some embodiments, the first layer 16 can include a low density polyethylene (LDPE), a linear low density polyethylene (LLDPE), a high density polyethylene (HDPE), a mixture thereof, or any suitable alternative. In some embodiments, the first layer 16 can include a blend of at least two polyolefins. In some embodiments, the first layer 16 comprises a blend of LDPE and HDPE. The first layer 16 may suitably comprise, consist of, or consist essentially of a polyethylene such as LDPE, LLDPE, HDPE, or a combination thereof. In some embodiments, the LDPE is Chevron Phillips MarFlex 1018. Colors of the polyethylene layer can vary.

In illustrative embodiments, it may be advantageous for the first layer 16 to have a particular thickness. For example, in some embodiments, a thickness of the polyethylene film of the first layer 16 can be sufficiently thick to be made into tapes, with thicker polyethylene film layers being more robust, tougher, and easier to use. In some embodiments, a thickness of the polyethylene film 10 can range from about 4 mils to about 16 mils. A thickness of the first layer 16 can be approximately in a range of about 3 mils to about 10 mils. In some embodiments, the first layer 16 can be less than about 10 mils thick. In some embodiments, the first layer 14 is at least about 9 mils or at least about 8 mils thick. In some embodiments, the first layer 14 is about 7 mils, about 6 mils, about 5 mils, about 4 mils, or about 3 mils thick.

The adhesive tape 10 can include the adhesive layer 18 directly adjacent to the first layer 16, as shown in FIG. 1B. The adhesive layer 18 can include an adhesive. In some embodiments, the adhesive is a rubber based adhesive or a hot melt adhesive. For example, the adhesive can include one or more of synthetic rubber, acrylic, modified rubber, natural rubber, silicone, and/or hot melt adhesive. The hot melt adhesive may be based on acrylate chemistry. Illustratively, the adhesive may be selected based on the bond strength/release characteristics required for a specific application.

In some embodiments, the adhesive layer 18 can be approximately in a range of about 1 mils to about 6 mils thick. In some embodiments, the adhesive layer 18 can be about 5 mils, about 4 mils, about 3 mils, about 2.5 mils, about 2 mils, or about 1 mil thick.

While a polyethylene film tape is discussed throughout this disclosure, a person skilled in the art will recognize that the disclosed features can apply to duct tape, foil tape, and so forth. The tape 10 of the present embodiments can be used in a variety of applications. For example, the tape can be used in stucco/plaster/seaming and splicing applications, such as B&C stucco applications, and B&C & Pool/Spa Plaster Applications, to provide for masking and microedging during application. In some embodiments, the tape 10 of the present embodiments can be used in clean removable or permanent applications. Additional applications of the tape 10 of the present disclosure can include seaming, sealing, and splicing applications, such as seal, seam, patch, hang and repair sheeting materials and/or tarps, general purpose sealing, splicing and seaming, splicing coated or uncoated papers or corrugate, foil slicing, tape splicing/manufacturing, seaming FR Correx®, seaming temporary enclosures and scaffold surrounds, Seam and patch shrink wrap for indoor/outdoor storage of marine, RV, and other equipment, film to film splicing, seaming vapor barrier films & underlayment, Seaming reinforced film, splicing and seaming heavy weight materials, polyethylene splicing and patching, and splicing and seaming heavy-weight materials subjected to high abrasion and stress.

For bonding and repair applications, the tape 10 can be applied to agricultural bagging, greenhouse repair, bonding of plastic, masonry, vinyl, stucco & metal, repair, remodel & remediation applications for marine shipyard, manufacturing environments and more where FR materials are used, concrete underlayment applications including patch, repair and sealing penetrations coming through the slab, splicing heavy duty floor covering, and temporary enclosures and containment areas for remediation and marine applications.

In surface protection applications, the tape 10 can provide temporary outdoor surface protection, temporary surface & floor protection, and surface protection in Aerospace, automotive & manufacturing applications. For masking, marking, and striping, the tape 10 can provide masking for stucco and plaster, general purpose outdoor masking, protection around window and door frames, decorative markings and striping, and color coding and isle marking.

Some non-limiting examples of industry specific applications can include NFPA701 Flame Propagation Applications, ASTM E84 Applications, UL 510 Applications, and DPM 871-2, 871-3, 877-1 & 881 Applications.

Some specialty applications can include moisture and chemical block during screen printing, disposal bags, abatement, low VOC applications, outdoor wire hold down, seal waste, bundling wrapping, and repairs, temporary hold down thermal insulation outerwrap, securing wire strands during customer weave and manufacture, industrial fabricating applications, bondbreaker tape, labeling and color coding, hang and patch poly sheeting, waterproof packaging, protective overlaminate for graphics, signs, and placards, surface protection against moisture, UV, solvents and abrasion, and bonding to low surface energy materials.

In some embodiments, the tape 10 can include a flame retardant layer thereon and/or UV additives. Examples of these compounds are known to one skilled in the art.

The adhesive tape can include a measurable adhesion to a release layer or release liner 20, as shown in FIG. 1C. As shown, the release layer 20 can include a layer of material that adheres to the adhesive layer 18 and affixes thereto that can be peeled to expose the adhesive 18. An adhesion to the release layer 20 measurement can measure how well an adhesive tape 10 would peel from an underlying release layer 20 of a self-wound tape. In some embodiments, the adhesive tape 10 can have an adhesion to the release layer less than about 40 oz., less than about 30 oz., or less than about 25 oz., as measured by PSTC-101. In some embodiments, the adhesion to the release layer for the adhesive tape 10 can be about 15 oz., about 18 oz., about 20 oz., about 21 oz., about 22 oz., about 23 oz., about 24 oz., about 25 oz., about 26 oz., about 27 oz., about 28 oz., about 29 oz., about 30 oz., about 32 oz., about 34 oz., about 36 oz., about 38 oz., or about 40 oz., as measured by PSTC-101. In some embodiments, the adhesive tape 10 can have an adhesion to release layer in a range of about 15 oz. to about 40 oz., about 15 oz. to about 35 oz., about 15 oz. to about 30 oz., or about 20 oz. to about 30 oz., as measured by PSTC-101. In some embodiments, the adhesive tape can have an adhesion to release layer of about 24 oz., as measured by PSTC-101.

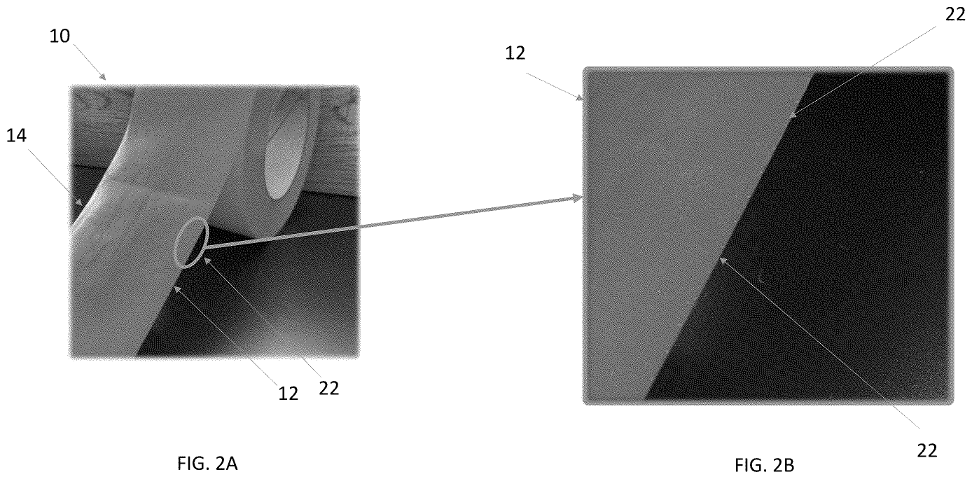

FIGS. 2A-2B illustrate an exemplary embodiment of the polyethylene tape 10 of the present disclosure having microfractures 22 formed in the edges of the tape 10. The microfractures 22 can take the form of lines that functions as tear starts on the edges 12, 14 of the tape 10 for use in foil and other applications to promote easier tearability than conventional straight edge products. In some embodiments, the microfractures 22 can be formed by microembossing slits or lines into the edges 12, 14 of the tape to form these slits along the edges thereof. As shown, the microfractures 22 can be formed in both the first edge 12 and the second edge 14 of the tape 10, though in some embodiments the microfractures can be limited to a single edge. The microfractures 22 can be spaced along the first and second edges 12, 14 at predetermined distances to allow tearing of pieces of the tape 10 during use. Spacing of the microfractures 22 can vary based on a thickness of the PE film 16, with thicker PE film layers having smaller spacings between adjacent microfractures 22 to promote ease of tearing. For example, for a thickness of the first layer 16 in approximately a range of about 3 mils to about 10 mils, spacing between adjacent microfractures 22 can be approximately in a range of about 1 millimeter to about 242 millimeters. In some embodiments, the spacing between adjacent microfractures 22 can depend on a thickness of the adhesive layer 18, and/or the tape 10. Moreover, in some embodiments a spacing between adjacent microfractures 22 can vary based on an overall thickness of the tape 10. That is, for thicknesses of the tape 10 that range from about 1 mil to about 16 mil, as discussed above, the spacing between adjacent microfractures 22 can be approximately in a range of about 1 millimeter to about 242 millimeters, with the spacing varying for decreased and/or increased thicknesses of the tape 10.

As shown in greater detail in FIG. 2B, a depth of the micro-fractured cuts on both edges 12, 14 of the tape 10 can appear to be substantially straight such that they may allow for masking that can still hold up in stucco applications. Moreover, use of microfractures 22 can ensure that end users will not have to change the application method based on roll to roll variations.

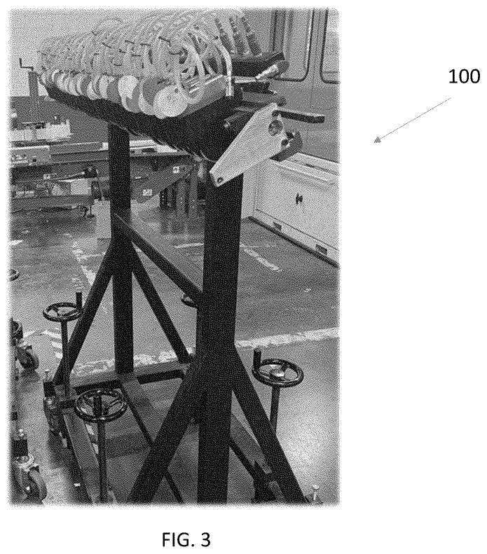

Microfractures within the tape 10 can be formed using a splitting knife and disc machine 30. FIG. 3 illustrates an exemplary embodiment of a prior art cutting machine 100 that can be used to form the dual-edge slitting of FIG. 1A and/or the microfractures 22 of FIGS. 2A-2B. The machine can include a microfracture cutting edge that can cut two rolls of tape 10 side by side, which creates microfracture formations or serrations on opposite edges 12, 14 of the tapes, while keeping the other edges straight, as shown in FIG. 1A, for example. Spacing between adjacent microfractures 22 can be consistent across the tape to allow pieces of substantially equal size to be torn off, resulting in predetermined ease of use of the tape 10.

As noted above, the disclosed features can apply to duct tape, foil tape, and so forth. Moreover, various properties of the above-listed ingredients may be found in Technical Data Sheets that correspond to each of the following non-limiting examples of tapes: Polyken 784, Polyken 784SW, Polyken 727, Polyken 757, Polyken 758, Polyken 767UV, Polyken 769UV, Polyken 781, Polyken 801, Polyken 809, Polyken 823, Polyken 824, Polyken 827, Polyken 836, Polyken 853, Polyken 853UV, Polyken 857, Polyken 859, Polyken 947, Polyken 949FR, PATCO 502R, PATCO 503A, PATCO 503R, PATCO 504A, and/or PATCO 505R-53, among others.
Clause 1. An adhesive tape, comprising: a first layer comprising a polyethylene material.
Clause 2. The multilayer stretch film of clause 1, any other suitable clause, or any combination of suitable clauses, wherein the first layer extends from a first edge to a second edge.
Clause 3. The multilayer stretch film of clause 2, any other suitable clause, or any combination of suitable clauses, further comprising a second layer comprising an adhesive.
Clause 4. The multilayer stretch film of clause 3, any other suitable clause, or any combination of suitable clauses, wherein the first edge comprises a substantially straight edge configured to form clean masking lines.
Clause 5. The multilayer stretch film of clause 4, any other suitable clause, or any combination of suitable clauses, wherein the second edge comprises one or more cutouts formed therein.
Clause 6. The multilayer stretch film of clause 5, any other suitable clause, or any combination of suitable clauses, wherein the one or more cutouts further comprise serrations that form concave grooves.
Clause 7. The multilayer stretch film of clause 6, any other suitable clause, or any combination of suitable clauses, wherein the concave grooves are distributed substantially uniformly along the second edge.
Clause 8. The multilayer stretch film of clause 5, any other suitable clause, or any combination of suitable clauses, wherein the one or more cutouts comprise microfracture edges that form pre-made tears in the first layer.
Clause 9. The multilayer stretch film of clause 8, any other suitable clause, or any combination of suitable clauses, wherein the microfracture edges are distributed substantially uniformly along the second edge.
Clause 10. The multilayer stretch film of clause 8, any other suitable clause, or any combination of suitable clauses, wherein a spacing between the microfracture edges is based on a thickness of the first layer, the second layer, or a combination of the first and second layers.
Clause 11. The multilayer stretch film of clause 8, any other suitable clause, or any combination of suitable clauses, wherein a spacing between the microfracture edges is based on a thickness of the first layer, the second layer, or a combination of the first and second layers.
Clause 12. The multilayer stretch film of clause 8, any other suitable clause, or any combination of suitable clauses, wherein the microfracture edges are microembossed
Clause 13. The multilayer stretch film of clause 5, any other suitable clause, or any combination of suitable clauses, wherein a thickness of the first layer is approximately in a range from about 3 mils to about 10 mils.
Clause 14. The multilayer stretch film of clause 5, any other suitable clause, or any combination of suitable clauses, wherein the adhesive tape is configured for use in stucco applications.
Clause 15. The multilayer stretch film of clause 5, any other suitable clause, or any combination of suitable clauses, wherein the tape is configured to be used in one or more of NFPA701 Flame Propagation Applications, ASTM E84 Applications, UL 510 Applications, and DPM 871-2, 871-3, 877-1 & 881 Applications.
Clause 16. The multilayer stretch film of clause 5, any other suitable clause, or any combination of suitable clauses, wherein the first layer comprises a low density polyethylene (LDPE), a linear low density polyethylene (LLDPE), a high density polyethylene (HDPE), or a mixture thereof.
Clause 17. A masking tape comprising: a first layer comprising a polyethylene material.
Clause 18. The multilayer stretch film of clause 17, any other suitable clause, or any combination of suitable clauses, wherein the first layer extends from a first edge to a second edge.
Clause 19. The multilayer stretch film of clause 18, any other suitable clause, or any combination of suitable clauses, further comprising a second layer comprising an adhesive.
Clause 20. The multilayer stretch film of clause 19, any other suitable clause, or any combination of suitable clauses, wherein at least one edge comprises a series of weakened areas.
Clause 21. The multilayer stretch film of clause 20, any other suitable clause, or any combination of suitable clauses, wherein the series of weakened areas are microfracture edges that form pre-made tears in the first layer.
Clause 22. The multilayer stretch film of clause 21, any other suitable clause, or any combination of suitable clauses, wherein the microfracture edges are distributed substantially uniformly along the second edge.
Clause 23. The multilayer stretch film of clause 21, any other suitable clause, or any combination of suitable clauses, wherein a first edge of the at least one edge has the series of weakened area and a second edge of the at least one edge is substantially straight and is free of weakened areas.

1. An adhesive tape, comprising:
a first layer comprising a polyethylene material that extends from a first edge to a second edge;
a second layer comprising an adhesive;
wherein the first edge comprises a substantially straight edge configured to form clean masking lines and the second edge comprises one or more cutouts formed therein.

2. The tape of claim 1, wherein the one or more cutouts further comprise serrations that form concave grooves.

3. The tape of claim 2, wherein the concave grooves are distributed substantially uniformly along the second edge.

4. The tape of claim 1, wherein the one or more cutouts comprise microfracture edges that form pre-made tears in the first layer.

5. The tape of claim 4, wherein the microfracture edges are distributed substantially uniformly along the second edge.

6. The tape of claim 4, wherein a spacing between the microfracture edges is based on a thickness of the first layer, the second layer, or a combination of the first and second layers.

7. The tape of claim 4, wherein the microfracture edges are microembossed.

8. The tape of claim 1, wherein a thickness of the first layer is approximately in a range from about 3 mils to about 10 mils.

9. The tape of claim 1, wherein the adhesive tape is configured for use in stucco applications.

10. The tape of claim 1, wherein the tape is configured to be used in one or more of NFPA701 Flame Propagation Applications, ASTM E84 Applications, UL 510 Applications, and DPM 871-2, 871-3, 877-1 & 881 Applications.

11. The tape of claim 1, wherein the first layer comprises a low density polyethylene (LDPE), a linear low density polyethylene (LLDPE), a high density polyethylene (HDPE), or a mixture thereof.

12. A masking tape, comprising:
a first layer comprising a polyethylene material that extends from a first edge to a second edge;
a second layer comprising an adhesive;
wherein at least one edge comprises a series of weakened areas.

13. The masking tape of claim 12, wherein the series of weakened areas are microfracture edges that form pre-made tears in the first layer.

14. The masking tape of claim 13, wherein the microfracture edges are distributed substantially uniformly along the second edge.

15. The masking tape of claim 13, wherein a first edge of the at least one edge has the series of weakened area and a second edge of the at least one edge is substantially straight and is free of weakened areas.
